(19) United States
(12) Patent Application Publication
(10) Pub. No.: US 2024/0317943 A1
(43) Pub. Date: Sep. 26, 2024

(54) SILICONE HYDROGELS

(71) Applicant: Bausch + Lomb Ireland Limited, Dublin (IE)

(72) Inventors: James Anthony DiBella, JR., Penfield, NY (US); Wendy G. Ahearn, Rochester, NY (US); Alok Kumar Awasthi, Pittsford, NY (US)

(21) Appl. No.: 18/422,196

(22) Filed: Jan. 25, 2024

Related U.S. Application Data
(60) Provisional application No. 63/453,851, filed on Mar. 22, 2023.

(51) Int. Cl. C08G 77/26; C08G 77/50

(52) U.S. Cl. CPC C08G 77/26; C08G 77/50

(57) ABSTRACT

A silicone hydrogel which is a polymerization product of a monomeric mixture including (a) one or more monofunctional silicone monomers represented by a structure of Formula I:

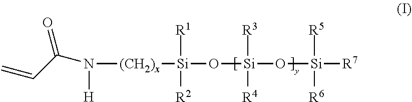

wherein R¹, R², R³ and R⁴ are independently hydrogen, a C₁ to C₁₂ alkyl group, a C₁ to C₁₂ halo alkyl group, a C₃ to C₁₂ cycloalkyl group, a C³ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 15, and (b) one or more silicone hydrogel-forming silicone comonomers.

### PRIORITY CLAIM

The present application claims priority to U.S. Provisional Patent Application Ser. No. 63/453,851, entitled “Silicone Hydrogels,” filed Mar. 22, 2023, the content of which is incorporated by reference herein in its entirety.

### BACKGROUND

Hydrogels represent a desirable class of materials for many biomedical applications, including contact lenses and intraocular lenses. Hydrogels are hydrated, cross-linked polymeric systems that contain water in an equilibrium state. Silicone hydrogels are a known class of hydrogels and are characterized by the inclusion of a silicone-containing material. Typically, a silicone-containing monomer is copolymerized by free radical polymerization with a hydrophilic monomer, with either the silicone-containing monomer or the hydrophilic monomer functioning as a crosslinking agent (a crosslinker being defined as a monomer having multiple polymerizable functionalities) or a separate crosslinker may be employed.

### SUMMARY

In accordance with an illustrative embodiment, a silicone hydrogel is a polymerization product of a monomeric mixture comprising:

(a) one or more monofunctional silicone monomers represented by a structure of Formula I:

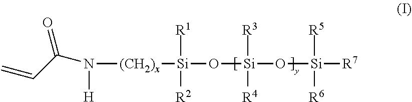

wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 15, and

(b) one or more silicone hydrogel-forming silicone comonomers.

In accordance with another illustrative embodiment, a method for making a silicone hydrogel comprises:

(a) curing a monomeric mixture in a mold, the monomeric mixture comprising:

(i) one or more monofunctional silicone monomers represented by a structure of Formula I:

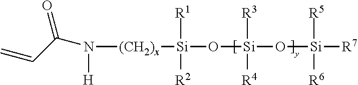

wherein R¹, R², R³, R⁴, R⁵, R⁶, R⁷, x and y are as defined herein, and

(ii) one or more silicone hydrogel-forming silicone comonomers, and

(b) releasing the silicone hydrogel from the mold.

### DETAILED DESCRIPTION

Various illustrative embodiments described herein are directed to silicone hydrogels having improved oxygen permeability and methods for their fabrication.

Hydrogels represent a desirable class of materials for contact lenses. A hydrogel is a hydrated cross-linked polymeric system that contains water in an equilibrium state. Hydrogel lenses offer relatively high oxygen permeability as well as desirable biocompatibility and comfort.

Oxygen permeability (Dk) is one important factor in contact lens design to maintain ocular health for contact lens wearers. For example, a contact lens must allow oxygen to reach the cornea in an amount which is sufficient for long-term corneal health. The contact lens must also allow oxygen from the surrounding air to reach the cornea because the cornea does not receive oxygen from the blood supply like other tissue. “Soft” contact lenses conform closely to the shape of the eye, so oxygen cannot easily circumvent the lens. Thus, soft contact lenses must allow oxygen to diffuse through the lens to reach the cornea.

Another ophthalmic compatibility requirement for soft contact lenses is that the lens must not strongly adhere to the eye. For example, a consumer must be able to easily remove the lens from the eye for disinfecting, cleaning, or disposal of the lens. However, the lens must also be able to move on the eye in order to encourage tear flow between the lens and the eye. Tear flow between the lens and eye allows for debris, such as foreign particulates or dead epithelial cells, to be swept from beneath the lens and, ultimately, out of the tear fluid. Thus, a contact lens must not adhere to the eye so strongly that adequate movement of the lens on the eye is inhibited.

Soft contact lens materials are made by polymerizing and crosslinking hydrophilic monomers such as 2-hydroxyethyl methacrylate (HEMA) or N-vinyl pyrrolidone (NVP). The polymers produced by polymerizing these hydrophilic monomers exhibit significant hydrophilic character themselves and are capable of absorbing a significant amount of water in their polymeric matrices. Due to their ability to absorb water, these polymers are often referred to as “hydrogels”. These hydrogels are optically clear and, due to their high levels of water of hydration, are useful materials for making soft contact lenses. However, these hydrogels are known to have poor levels of oxygen permeability.

Silicone hydrogels (SiHy) such as contact lenses, which are made of a hydrated, crosslinked polymeric material that contains silicone and a certain amount of water within the lens polymer matrix at equilibrium, are increasingly becoming popular as compared to the conventional hydrogels, because they have minimal adverse effects on corneal health due to their high oxygen permeability. However, incorporation of silicone in a contact lens material can have undesirable effects on the hydrophilicity and wettability of silicone hydrogels, because silicone is hydrophobic and has a great tendency to migrate onto the lens surface being exposed to air. Accordingly, the optimum contact lens would have at least both excellent oxygen permeability and excellent tear fluid wettability.

The illustrative embodiments described herein overcome the foregoing drawbacks by using one or more of the monofunctional silicone monomers of Formula I to form silicone hydrogels having improved oxygen permeability.

As used herein, the term “SiHy” shall be understood to mean silicone hydrogel.

As used herein, the term “hydrogel” or “hydrogel material” refers to a crosslinked polymeric material that has a three-dimensional polymer network (i.e., polymer matrix), is insoluble in water, but can hold at least about 10 percent by weight of water in its polymer matrix when it is fully hydrated.

As used herein, the term “silicone hydrogel” or “SiHy” interchangeably refers to a hydrogel containing silicone. A silicone hydrogel (SiHy) typically is obtained by copolymerization of a polymerizable composition comprising at least one silicone-containing vinylic monomer or at least one silicone-containing vinylic macromer or at least one silicone-containing prepolymer having ethylenically unsaturated groups.

As used herein, the term “(meth)” denotes an optional methyl substituent. Thus, terms such as “(meth)acrylate” denotes either methacrylate or acrylate, and “(meth)acrylamide” denotes either methacrylamide or acrylamide.

In accordance with non-limiting illustrative embodiments, a silicone hydrogel disclosed herein is a polymerization product of a monomeric mixture which comprises:

(a) a monofunctional silicone monomer represented by a structure of Formula I:

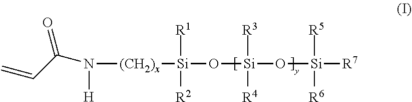

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15, and

(b) one or more silicone hydrogel-forming silicone comonomers.

In some embodiments, R¹, R², R³ and R⁴ of the monofunctional silicone monomer represented by a structure of Formula I are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In some embodiments, R¹, R², R³ and R⁴ of the monofunctional silicone monomer represented by a structure of Formula I are independently hydrogen, a C₁ to C₆ alkyl group; R⁵, R⁶ and R⁷ are independently a straight or branched C₁ to C₆ alkyl group; x is from 1 to 6; and y is from 3 to 8.

In some embodiments, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

Representative examples of alkyl groups for use herein include, by way of example, a straight or branched alkyl chain radical containing carbon and hydrogen atoms of from 1 to about 30 carbon atoms or from 1 to about 12 carbon atoms or from 1 to about 6 carbon atoms with or without unsaturation, to the rest of the molecule, e.g., methyl, ethyl, n-propyl, 1-methylethyl (isopropyl), n-butyl, n-pentyl, methylene, ethylene, etc., and the like, optionally containing one or more heteroatoms, e.g., O and N, and the like, or one or more halogen atoms, e.g., fluorine, chlorine, bromine, and iodine, to form a halo alkyl group.

Representative examples of cycloalkyl groups for use herein include, by way of example, a substituted or unsubstituted, non-aromatic mono or multicyclic ring system of about 3 to about 30 carbon atoms or from 3 to about 12 carbon atoms or from 3 to about 6 carbon atoms such as, for example, cyclopropyl, cyclobutyl, cyclopentyl, cyclohexyl, perhydronapththyl, adamantyl and norbornyl groups, bridged cyclic groups or sprirobicyclic groups, e.g., spiro-(4, 4)-non-2-yl and the like, optionally containing one or more heteroatoms, e.g., O and N, and the like to form a heterocycloalkyl group.

Representative examples of cycloalkylalkyl groups for use herein include, by way of example, a substituted or unsubstituted, cyclic ring-containing radical containing from about 4 to about 30 carbon atoms or from 3 to about 6 carbon atoms directly attached to the alkyl group which is then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like to form a heterocycloalkylalkyl group.

Representative examples of cycloalkenyl groups for use herein include, by way of example, a substituted or unsubstituted cyclic ring-containing radical containing from about 3 to about 30 carbon atoms or from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like to form a heterocycloalkenyl group.

Representative examples of aryl groups for use herein include, by way of example, a substituted or unsubstituted, monoaromatic or polyaromatic radical containing from about 6 to about 30 carbon atoms or from about 6 to about 12 carbon atoms such as, for example, phenyl, naphthyl, tetrahydronapthyl, indenyl, biphenyl and the like, optionally containing one or more heteroatoms, e.g., O and N, and the like to form a heteroaryl group.

In an illustrative embodiment, the monofunctional silicone monomer represented by the structure of Formula I is either commercially available from such sources as ShinEtsu or can be made by methods within the purview of one skilled in the art. For example, in an illustrative embodiment, the monofunctional silicone monomer represented by the structure of Formula I can be prepared according to the following reaction Scheme I.

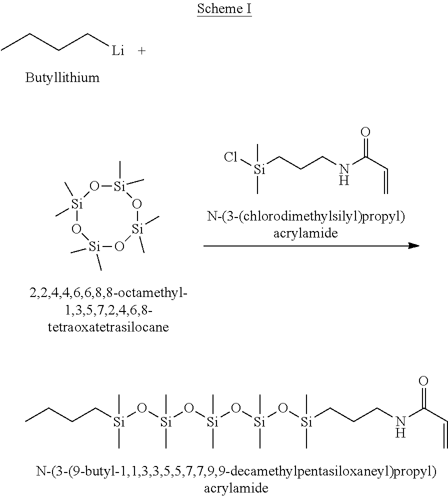

In some embodiments, the one or more monofunctional silicone monomers represented by a structure of Formula I as disclosed herein can be present in the monomeric mixture in an amount ranging from about 5 wt. % to about 40 wt. %, based on the total weight of the monomeric mixture. In some embodiments, the one or more silicone monomers represented by a structure of Formula I as disclosed herein can be present in the monomeric mixture in an amount ranging from about 7 wt. % to about 15 wt. %, based on the total weight of the monomeric mixture.

The monomeric mixture further contains one or more silicone hydrogel-forming silicone comonomers as component (b). Representative silicone hydrogel-forming silicone comonomers for use in the formation of silicone hydrogels according to the illustrative embodiments are well known in the art and numerous examples are provided in U.S. Pat. Nos. 4,136,250; 4,153,641; 4,740,533; 5,034,461; 5,070,215; 5,260,000; 5,310,779; and 5,358,995. Specific examples of suitable materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

In an illustrative embodiment, as may be combined with one or more of the preceding paragraphs, the one or more silicone hydrogel-forming silicone comonomers can include, as a class of representative silicone hydrogel-forming silicone comonomers, one or more non-bulky organosilicon-containing monomers. An “organosilicon-containing monomer” as used herein contains at least one [siloxanyl] or at least one [silyl-alkyl-siloxanyl] repeating unit, in a monomer, macromer or prepolymer. In an illustrative embodiment, an example of a non-bulky organosilicon-containing monomers is represented by a structure of Formula IIa:

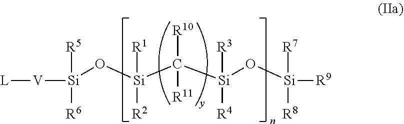

wherein L is an ethylenically unsaturated polymerizable group, V is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, O-vinyl carbamates, N-vinyl carbamates, and (meth)acrylamides.

Linking groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In some embodiments, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In some embodiments, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

Non-bulky organosilicon-containing monomers represented by a structure of Formula IIa are known in the art, see, e.g., U.S. Pat. Nos. 7,915,323, 7,994,356, 8,420,711, 8,827,447 and 9,039,174, the contents of which are incorporated by reference herein.

In an illustrative embodiment, as may be combined with one or more of the preceding paragraphs, the one or more non-bulky organosilicon-containing monomers can also comprise a compound represented by a structure of Formula IIb:

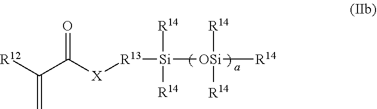

wherein R¹² is H or methyl; X is O or NR¹⁶; wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IIb are known in the art, see, e.g., U.S. Pat. Nos. 8,703,891, 8,937,110, 8,937,111, 9,156,934 and 9,244,197, the contents of which are incorporated by reference herein.

Representative examples of the non-bulky organosilicon-containing monomers

include:

M1EDS6: a compound having the structure and available from Gelest:

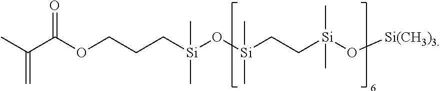

MCR-M11: a compound having the structure:

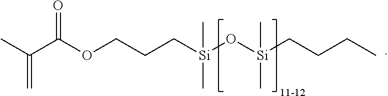

M1-MCR-C_{12:} a compound having the structure:

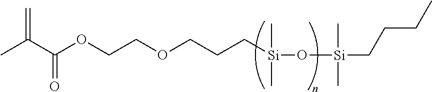

wherein n is an average of 12.

In an illustrative embodiment, as may be combined with one or more of the preceding paragraphs, the one or more silicone hydrogel-forming silicone comonomers can include, as a class of representative silicone hydrogel-forming silicone comonomers, one or more polysiloxane prepolymers represented by a structure of Formula III:

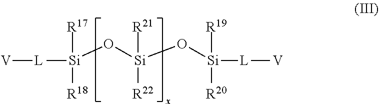

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

A hydroxyl-containing reactive functional end group for use herein is a group of the general Formula-OH. Representative examples of amine-containing reactive functional end groups for use herein include, by way of example, a (meth)acrylamide-containing reactive functional end group.

Linking group L is independently a straight or branched alkyl group, cycloalkyl group, an aryl group, an ether or polyether group, and an ester group as defined herein.

A representative example of a polysiloxane prepolymer is as follows:

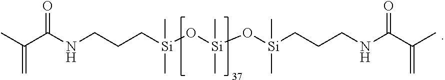

Methods for making the polysiloxane prepolymers described herein are well known and within the purview of one skilled in the art. In addition, the polysiloxane prepolymers are also commercially available from such sources as, for example, Gelest, Silar, Shin-Etsu, Momentive and Siltech.

In an illustrative embodiment, as may be combined with one or more of the preceding paragraphs, the one or more silicone hydrogel-forming silicone comonomers can include, as a class of representative silicone hydrogel-forming silicone comonomers, one or more bulky silicone-containing monomers. In an embodiment, suitable bulky silicone-containing monomers include, for example, a bulky polysiloxanylalkyl (meth)acrylic monomer, a bulky polysiloxanylalkyl carbamate monomer and mixtures thereof. A representative example of a bulky silicone-containing monomer includes a bulky silicone-containing monomer represented by a structure of Formula IV:

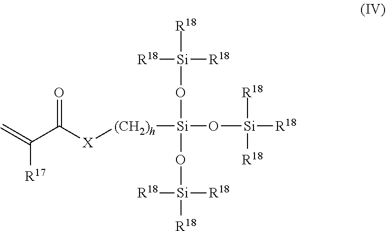

wherein X denotes —O— or —NR¹⁹—, where each R¹⁹ is hydrogen or a C₁-C₄ alkyl group; R¹⁷ independently denotes hydrogen or methyl; each R¹⁸ independently denotes a lower alkyl radical such as a C₁-C₆ group, a phenyl radical or a group represented by the following structure:

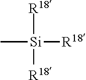

wherein each R¹⁸′ independently denotes a lower alkyl radical or a phenyl radical; and h is 1 to 10; or a bulky silicone-containing monomer represented by a structure of Formula V:

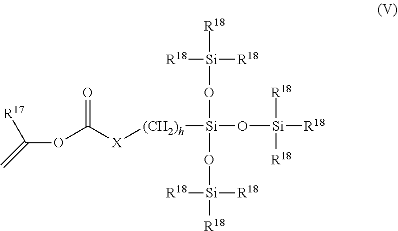

wherein X denotes —NR¹⁹— wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

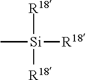

wherein each R¹⁸′ independently denotes a lower alkyl radical or a phenyl radical; and h is 1 to 10.

Representative examples of bulky silicone-containing monomers include 3-methacryloyloxypropyltris(trimethylsiloxy)silane or tris(trimethylsiloxy)silylpropyl methacrylate, sometimes referred to as TRIS, tris(trimethylsiloxy)silylpropyl vinyl carbamate, sometimes referred to as TRIS-VC, pentamethyldisiloxanyl methylmethacrylate, phenyltetramethyl-disiloxanylethyl acetate, and methyldi(trimethylsiloxy)methacryloxymethyl silane, (3-methacryloxy-2-hydroxy propoxy)propyl bis(trimethyl siloxy)methyl silane, sometimes referred to as Sigma and the like and mixtures thereof. In one embodiment, the bulky silicone-containing monomer is a tris(trialkylsiloxy)silylalkyl methacrylate-containing monomer such as a tris(trimethylsiloxy)silylpropyl methacrylate-containing monomer.

Such bulky silicone-containing monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

In an illustrative embodiment, as may be combined with one or more of the preceding paragraphs, the one or more silicone hydrogel-forming silicone comonomers can include, as a class of representative silicone hydrogel-forming silicone comonomers, one or more silicone-containing vinyl carbonate or vinyl carbamate monomers. Suitable one or more silicone-containing vinyl carbonate or vinyl carbamate monomers include, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

In an illustrative embodiment, as may be combined with one or more of the preceding paragraphs, the one or more silicone hydrogel-forming silicone comonomers can include, as a class of representative silicone hydrogel-forming silicone comonomers, one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacrylates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae VI and VII:

E(*D*A*D*G)ₐ*D*A*D*E′; or (VI)

E(*D*G*D*A)ₐ*D*A*D*E′; or (VII)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

* denotes a urethane or ureido linkage;

a is at least 1;

A independently denotes a divalent polymeric radical of Formula VIII:

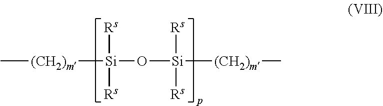

wherein each R^{S} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula IX:

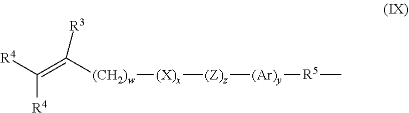

wherein: R³ is hydrogen or methyl;
R⁴ is hydrogen, an alkyl radical having 1 to 6 carbon atoms, or a —CO—Y—R⁶ radical wherein

### Y is —O—, —S— or —NH—;

R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

In an illustrative embodiment, as may be combined with one or more of the preceding paragraphs, the one or more silicone hydrogel-forming silicone comonomers can include, as a class of representative silicone hydrogel-forming silicone comonomers, one or more silicone-containing urethane monomers represented by Formula X:

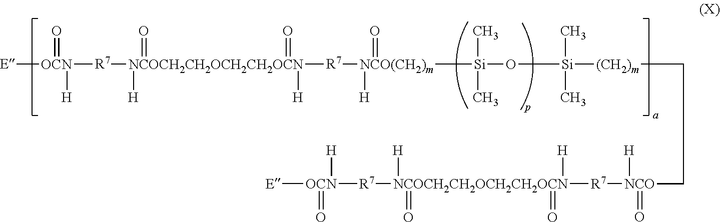

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

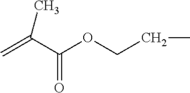

In another embodiment, a silicone hydrogel material comprises (in bulk, that is, in the monomeric mixture that is copolymerized) about 5 to about 50 percent, or from about 10 to about 25, by weight of one or more silicone macromonomers, about 5 to about 75 percent, or about 30 to about 60 percent, by weight of one or more polysiloxanylalkyl (meth)acrylic monomers, and about 10 to about 50 percent, or about 20 to about 40 percent, by weight of a hydrophilic monomer. In general, the silicone macromonomer is a poly(organosiloxane) capped with an unsaturated group at two or more ends of the molecule. In addition to the end groups in the above structural Formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the non-limiting embodiments described herein. The silane macromonomer may be a silicone-containing vinyl carbonate or vinyl carbamate or a polyurethane-polysiloxane having one or more hard-soft-hard blocks and end-capped with a hydrophilic monomer.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formula XI:

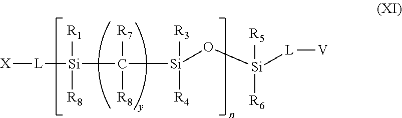

wherein X is the residue of a ring opening agent; L is the same or different and is a linking group or a bond; V is an ethylenically unsaturated polymerizable group; R¹, R², R³, R⁴, R⁵, R⁶ are independently hydrogen, an alkyl group, a haloalkyl group, a cycloalkyl group, a heterocycloalkyl group, an alkenyl group, a halo alkenyl group, or an aromatic group; R⁷ and R⁸ are independently hydrogen or an alkyl group wherein at least one of R⁷ or R⁸ is hydrogen; y is 2-7 and n is 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linking groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated polymerizable groups are well known to those skilled in the art. Non-limiting examples of ethylenically unsaturated polymerizable groups would include acrylates, methacrylates, vinyl carbonates, O-vinyl carbamates, N-vinyl carbamates, acrylamides and methacrylamides.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formula XII:

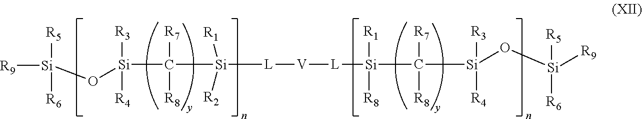

wherein L is the same or different and is a linking group or a bond; V is the same or different and is an ethylenically unsaturated polymerizable group; R¹, R², R³, R⁴, R⁵, R⁶ and R⁹ are independently hydrogen, an alkyl group, a haloalkyl group, a cycloalkyl group, a heterocycloalkyl group, an alkenyl group, a halo alkenyl group, or an aromatic group; R⁷ and R₈ are independently hydrogen or an alkyl group wherein at least one of R⁷ or R⁸ is hydrogen; y is 2-7 and n is 1-100.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formulae XIII and XIV:

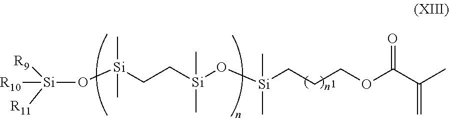

wherein R₉, R₁₀ and R₁₁ are independently hydrogen, an alkyl group, a haloalkyl group or other substituted alkyl groups; n is as defined above and n¹ is 0-10; and,

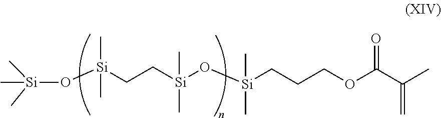

wherein n is 1 to 100, or n is 2 to 80, or n is 3 to 20, or n is 5 to 15.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formulas XV-XIX:

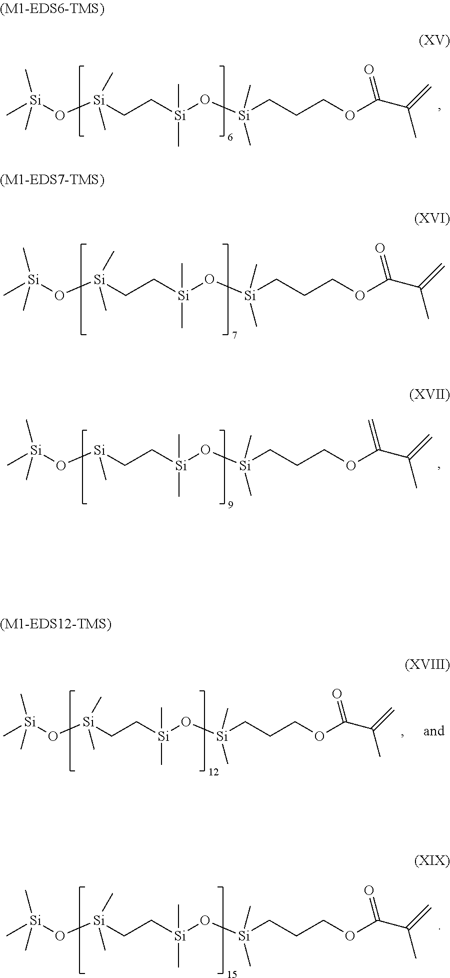

In an illustrative embodiment. as may be combined with one or more of the preceding paragraphs, the one or more silicone hydrogel-forming silicone comonomers can include, as a class of representative silicone hydrogel-forming silicone comonomers, one or more monomers of Formulas XX-XXII:

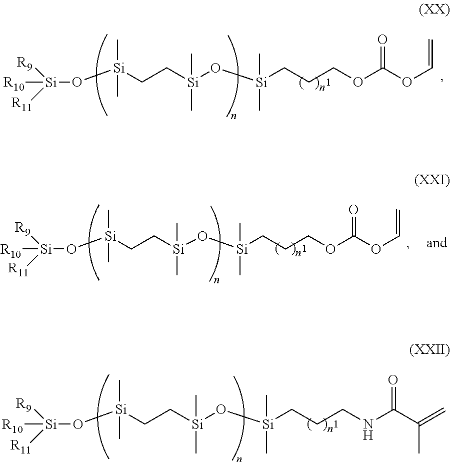

wherein R₉, R₁₀ and R₁₁ are independently hydrogen, an alkyl group, a haloalkyl group or other substituted alkyl groups and n and n¹ are as defined above.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formulas XXIII-XXV:

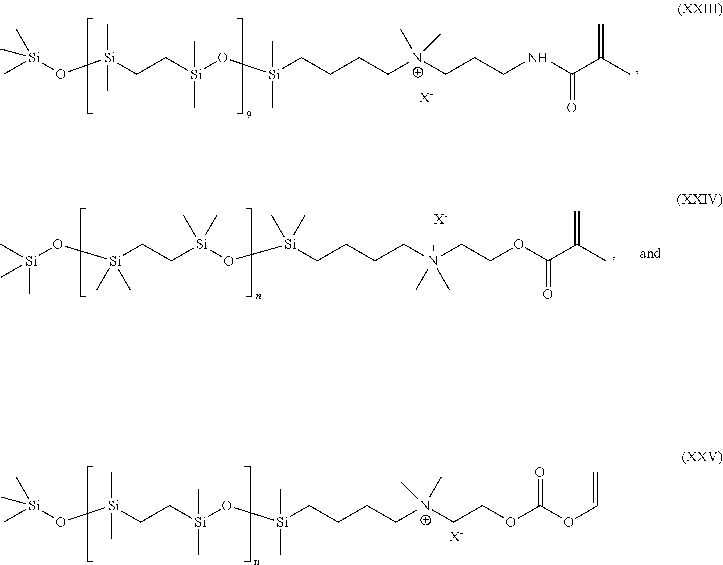

wherein n is as defined above and X⁻ is a counterion to provide an overall neutral charge.

Counterions capable of providing an overall neutral charge are well known to those of ordinary skill in the art and would include, for example, halide ions.

In an illustrative embodiment, as may be combined with one or more of the preceding paragraphs, the one or more silicone hydrogel-forming silicone comonomers can include, as a class of representative silicone hydrogel-forming silicone comonomers, one or more monomers of Formula XXVI:

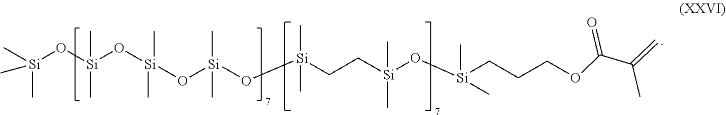

In accordance with one or more additional non-limiting illustrative embodiments, as may be combined with one or more of the preceding paragraphs, the one or more silicone hydrogel-forming silicone comonomers can be present in the monomeric mixture in a major amount. In accordance with one or more additional non-limiting illustrative embodiments, as may be combined with one or more of the preceding paragraphs, the one or more silicone hydrogel-forming silicone comonomers can be present in the monomeric mixture in an amount greater than about 50 wt. %, based on the total weight of the monomeric mixture. In some embodiments, the one or more silicone hydrogel-forming silicone comonomers can be present in the monomeric mixture in an amount greater than about 50 wt. % and up to 95 wt. %, based on the total weight of the monomeric mixture.

In accordance with one or more additional non-limiting illustrative embodiments, as may be combined with one or more of the preceding paragraphs, the one or more silicone hydrogel-forming silicone comonomers can be present in the monomeric mixture in an amount ranging from about 10 wt. % to about 60 wt. %, based on the total weight of the monomeric mixture. In another illustrative embodiment, the one or more silicone hydrogel-forming silicone comonomers can be present in the monomeric mixture in an amount ranging from about 15 wt. % to about 50 wt. %, based on the total weight of the monomeric mixture.

The above silicone materials are merely exemplary, and other materials for use as substrates that have been disclosed in various publications and are being continuously developed for use in contact lenses and other silicone hydrogels can also be used. For example, a silicone hydrogel can be formed from at least a cationic monomer such as cationic silicone-containing monomers or cationic fluorinated silicone-containing monomers.

In non-limiting illustrative embodiments, as may be combined with one or more of the preceding paragraphs, the monomeric mixture can further contain one or more hydrophilic comonomers. Suitable hydrophilic comonomers include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include, but are not limited to, methacrylic acid, acrylic acid and the like and mixtures thereof. Representative examples of acrylamides include, but are not limited to, alkylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), glycerol methacrylate and the like and mixtures thereof.

Additional hydrophilic comonomers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable silicone hydrogel-forming hydrophilic comonomers will be apparent to one skilled in the art. Mixtures of the foregoing hydrophilic comonomers can also be used in the monomeric mixtures herein.

In accordance with one or more additional non-limiting illustrative embodiments, as may be combined with one or more of the preceding paragraphs, the one or more hydrophilic comonomers can be present in the monomeric mixture in an amount ranging from about 20 wt. % to about 60 wt. %, based on the total weight of the monomeric mixture. In another illustrative embodiment, the one or more hydrophilic comonomers can be present in the monomeric mixture in an amount ranging from about 25 wt. % to about 45 wt. %, based on the total weight of the monomeric mixture.

In non-limiting illustrative embodiments, as may be combined with one or more of the preceding paragraphs, the monomeric mixture can further contain one or more crosslinking agents. Suitable crosslinking agents for use herein are known in the art. For example, in non-limiting illustrative embodiments, suitable one or more cross-linking agents include one or more crosslinking agents containing at least two ethylenically unsaturated reactive end groups. In one embodiment, the ethylenically unsaturated reactive end groups are (meth)acrylate-containing reactive end groups. In another embodiment, the ethylenically unsaturated reactive end groups are non-(meth)acrylate reactive end groups. In one embodiment, the ethylenically unsaturated reactive end groups are a combination of one or more (meth)acrylate-containing reactive end groups and one or more non-(meth)acrylate reactive end groups.

In an illustrative embodiment, useful one or more crosslinking agents containing at least two ethylenically unsaturated reactive end groups include, for example, one or more di-, tri-or tetra(meth)acrylate-containing crosslinking agents. In an illustrative embodiment, useful one or more di-, tri-or tetra(meth)acrylate-containing crosslinking agents include, for example, alkanepolyol di-, tri-or tetra(meth)acrylate-containing crosslinking agents such as, for example, one or more alkylene glycol di(meth)acrylate crosslinking agents, one or more alkylene glycol tri(meth)acrylate crosslinking agents, one or more alkylene glycol tetra(meth)acrylate crosslinking agents, one or more alkanediol di(meth)acrylate crosslinking agents, alkanediol tri(meth)acrylate crosslinking agents, alkanediol tetra(meth)acrylate crosslinking agents, agents, one or more alkanetriol di(meth)acrylate crosslinking agents, alkanetriol tri(meth)acrylate crosslinking agents, alkanetriol tetra(meth)acrylate crosslinking agents, agents, one or more alkanetetraol di(meth)acrylate crosslinking agents, alkanetetraol tri(meth)acrylate crosslinking agents, alkanetetraol tetra(meth)acrylate crosslinking agents and the like and mixtures thereof.

In an illustrative embodiment, one or more alkylene glycol di(meth)acrylate crosslinking agents include tetracthylene glycol dimethacrylate, ethylene glycol di(meth)acrylates having up to about 10 ethylene glycol repeating units, butyleneglycol di(meth)acrylate and the like. In one embodiment, one or more alkanediol di(meth)acrylate crosslinking agents include butanediol di(meth)acrylate crosslinking agents, hexanediol di(meth)acrylate and the like. In one embodiment, one or more alkanetriol tri(meth)acrylate crosslinking agents are trimethylol propane trimethacrylate crosslinking agents. In one embodiment, one or more alkanetetraol tetra(meth)acrylate crosslinking agents are pentaerythritol tetramethacrylate crosslinking agents.

In a non-limiting illustrative embodiment, suitable crosslinking agents include, for example, ethylene glycol diacrylate, diethylene glycol diacrylate, allyl acrylate, 1,3-propanediol diacrylate, 2,3-propanediol diacrylate, 1,6-hexanediol diacrylate, 1,4-butanediol diacrylate, tricthylene glycol diacrylate, cyclohexane-1,1-diyldimethanol diacrylate, 1,4-cyclohexanediol diacrylate, 1,3-adamantanediol diacrylate, 1,3-adamantanedimethyl diacrylate, 2,2-diethyl-1,3-propanediol diacrylate, 2,2-diisobutyl-1,3-propanediol diacrylate, 1,3-cyclohexanedimethyl diacrylate, 1,4-cyclohexanedimethyl diacrylate; neopentyl glycol diacrylate, tetraethyleneglycol diacrylate, polyethyleneglycol diacrylate; and their corresponding methacrylates.

In a non-limiting illustrative embodiment, suitable crosslinking agents include, for example, 1,4-butanediol diacrylate, 1,4-butanediol dimethacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, 1,3-propanediol diacrylate, 1,3-propanediol dimethacrylate, 1,6-hexanediol diacrylate, 1,6-hexanediol dimethacrylate, poly(ethylene glycol) diacrylate (Mn=700 Daltons), poly(ethylene glycol) dimethacrylate (Mn=700 Daltons), and poly(ethylene glycol) dimethacrylate (Mn=1000 Daltons).

In one embodiment, the one or more crosslinking agents containing at least two ethylenically unsaturated reactive end groups include at least one allyl-containing reactive end group and at least one (meth)acrylate-containing reactive end group. In an illustrative embodiment, the one or more crosslinking agents can be allyl methacrylate.

In non-limiting illustrative embodiments, as may be combined with one or more of the preceding paragraphs, the one or more crosslinking agents can be present in the monomeric mixture in a silicone hydrogel-forming amount. In non-limiting illustrative embodiments, as may be combined with one or more of the preceding paragraphs, the one or more crosslinking agents are present in the monomeric mixture in an amount of about 0.1 to about 3.0 wt. %, based on the total weight of the monomeric mixture. In non-limiting illustrative embodiments, as may be combined with one or more of the preceding paragraphs, the one or more crosslinking agents are present in the monomeric mixture in an amount of about 0.2 to about 1.0 wt. %, based on the total weight of the monomeric mixture.

In accordance with one or more additional non-limiting illustrative embodiments, as may be combined with one or more of the preceding paragraphs, the monomeric mixture can further contain one or more additional comonomers. In an illustrative embodiment, the one or more additional comonomers can include, for example, both an ethylenically unsaturated group (that permits the monomer to copolymerize with the hydrophilic comonomer) and an epoxide group (that does not react with the hydrophilic comonomer but remains to react with the copolymer). Suitable additional comonomers include, for example, glycidyl methacrylate, glycidyl acrylate, glycidyl vinylcarbonate, glycidyl vinylcarbamate, 4-vinyl-1-cyclohexene-1,2-epoxide and the like.

In non-limiting illustrative embodiments, the one or more additional comonomers can be present in the monomeric mixture in an amount ranging from about 1 wt. % to about 20 wt. %, based on the total weight of the monomeric mixture. In another illustrative embodiment, the one or more additional comonomers can be present in the monomeric mixture in an amount ranging from about 3 wt. % to about 10 wt. %, based on the total weight of the monomeric mixture.

In non-limiting illustrative embodiments, as may be combined with one or more of the preceding paragraphs, the monomeric mixture can further contain a reactive (polymerizable) ultraviolet (UV) light absorber and/or a reactive blue-light absorber. Suitable reactive UV light absorbers can be any known reactive UV light absorber. In non-limiting illustrative embodiments, suitable reactive UV light absorbers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d][1,2,3]triazol-2-yl)phenoxy)ethyl methacrylate.

In one illustrative embodiment, suitable UV light absorbers include, for example, one or more compounds of the following Formulas:

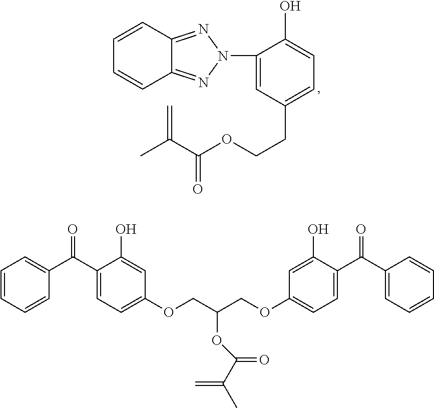 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1-[(4-benzoyl3-hydroxyphenoxy)methyl ester),

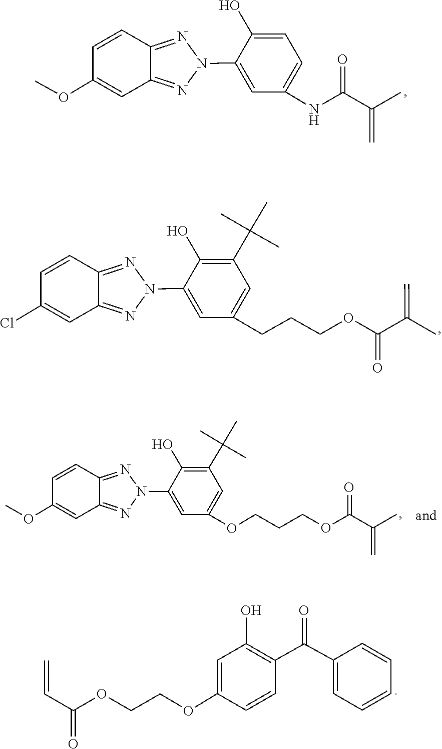

These compounds are merely illustrative and not intended to be limiting. Any known UV blocker or later developed UV blocker is contemplated for use herein.

In illustrative embodiments, the UV light absorbers can be present in the monomeric mixture in an amount ranging from about 0.1 to about 5 wt. %, based on the total weight of the monomeric mixture. In another illustrative embodiment, the UV light absorbers can be present in the monomeric mixture in an amount ranging from about 1.5 to about 2.5 wt. %, based on the total weight of the monomeric mixture. In yet another non-limiting illustrative embodiment, the UV light absorbers can be present in the monomeric mixture in an amount ranging from about 1.5 to about 2 wt. %, based on the total weight of the monomeric mixture.

Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference. In one embodiment, a blue-light absorbing dye is N-2-[3-(2′-methylphenylazo)-4-hydroxyphenyl]ethyl methacrylamide. In illustrative embodiments, the blue-light absorbers can be present in the monomeric mixture in an amount ranging from about 0.005 to about 1 wt. %, based on the total weight of the monomeric mixture. In another illustrative embodiment, the blue-light absorbers can be present in the monomeric mixture in an amount ranging from about 0.01 to about 1 wt. %, based on the total weight of the monomeric mixture.

In non-limiting illustrative embodiments, as may be combined with one or more of the preceding paragraphs, the monomeric mixture can further contain a diluent. Suitable diluents include, for example, at least one or more boric acid esters of a C₁ to C₈ monohydric alcohol, water-soluble or partly water-soluble monohydric alcohols and mixtures thereof. In one embodiment, a diluent includes, for example, at least one or more boric acid esters of a C₁ to C₈ monohydric alcohol. Suitable boric acid esters of a C₁ to C₈ monohydric alcohol include, for example, trimethyl borate, triethyl borate, tri-n-propyl borate, triisopropyl borate, tri-n-butyl borate, and tri-tert-butyl borate. Suitable water-soluble or partly water-soluble monohydric alcohols include, for example, monohydric alcohols having from 1 to 5 carbon atoms such as methanol, ethanol, isopropyl alcohol, 1-propanol, t-butyl alcohol, 2-butyl alcohol, 2-methyl-1-propanol, t-amyl alcohol and other C₅ isomers.

In non-limiting illustrative embodiments, as may be combined with one or more of the preceding paragraphs, the monomeric mixture contains about 5 wt. % to about 50 wt. % of the diluent, based on the total weight of the monomeric mixture. In one embodiment, the monomeric mixture contains about 15 wt. % to about 30 wt. % of the diluent, based on the total weight of the monomeric mixture.

The monomeric mixture may further contain, as necessary and within limits not to impair the purpose and effect of the illustrative embodiments, various additives such as an antioxidant, coloring agent, lubricant, internal wetting agent, toughening agent and the like and other constituents as are well known in the art.

The silicone hydrogels of the illustrative embodiments, e.g., contact lenses or intraocular lenses, can be prepared by polymerizing the foregoing monomeric mixtures to form a product that can be subsequently formed into the appropriate shape by, for example, lathing, injection molding, compression molding, cutting and the like. For example, in producing contact lenses, the initial mixture may be polymerized in tubes to provide rod-shaped articles, which are then cut into buttons. The buttons may then be lathed into contact lenses.

Alternately, the silicone hydrogels such as contact lenses may be cast directly in molds, e.g., polypropylene molds, from the mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the mixtures to be polymerized to a mold, and spinning the mold in a controlled manner while exposing the mixture to a radiation source such as UV light. Static casting methods involve charging the monomeric mixture between two mold sections, one mold section shaped to form the anterior lens surface and the other mold section shaped to form the posterior lens surface, and curing the mixture while retained in the mold assembly to form a lens, for example, by free radical polymerization of the mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat (thermal cure) and/or radiation, such as ultraviolet light, visible light, or high energy radiation. A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the initiator will be employed in the monomeric mixture at a concentration of about 0.01 to about 5 wt. % of the total mixture.

Polymerization is generally performed in a reaction medium, such as, for example, a solution or dispersion using a solvent, e.g., water or an alkanol containing from 1 to 4 carbon atoms such as methanol, ethanol or propan-2-ol. Alternatively, a mixture of any of the above solvents may be used.

Generally, polymerization can be carried out for about 15 minutes to about 72 hours, and under an inert atmosphere of, for example, nitrogen or argon. If desired, the resulting polymerization product can be dried under vacuum, e.g., for about 5 to about 72 hours, or left in an aqueous solution prior to use.

Polymerization of the mixtures will yield a polymer, that when hydrated, forms a hydrogel. When producing a hydrogel lens, the mixture may further include at least a diluent as discussed above that is ultimately replaced with water when the polymerization product is hydrated to form a hydrogel. In non-limiting illustrative embodiments, as may be combined with one or more of the preceding paragraphs, the silicone hydrogels disclosed herein can be high water content silicone hydrogels having an equilibrium water content of at least about 50 wt. %. In another illustrative embodiment, the silicone hydrogels disclosed herein can be high water content silicone hydrogels having an equilibrium water content of at least about 60 wt. %. In another illustrative embodiment, the silicone hydrogels disclosed herein can be high water content silicone hydrogels having an equilibrium water content of at least about 70 wt. %. In another illustrative embodiment, the silicone hydrogels disclosed herein can be high water content silicone hydrogels having an equilibrium water content of from about 50 wt. % to about 80 wt. %.

In non-limiting illustrative embodiments, as may be combined with one or more of the preceding paragraphs, the silicone hydrogels disclosed herein can have an oxygen permeability of greater than about 120 Barrers. In illustrative embodiments, the silicone hydrogels disclosed herein can have an oxygen permeability of greater than about 80 Barrers, e.g., from about 100 to about 150 Barrers.

The amount of diluent used should be less than about 50 wt. % and in most cases, the diluent content will be less than about 30 wt. %. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol; glycerine; liquid poly(ethylene glycol); alcohols; alcohol/water mixtures; ethylene oxide/propylene oxide block copolymers; low molecular weight linear poly(2-hydroxyethyl methacrylate); glycol esters of lactic acid; formamides; ketones; dialkylsulfoxides; butyl carbitol; borates as discussed herein and the like and mixtures thereof.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. If desired, the mixture used to produce the hydrogel lens may further include crosslinking and wetting agents known in the prior art for making hydrogel materials.

In the case of intraocular lenses, the monomeric mixtures to be polymerized may further include a monomer for increasing the refractive index of the resultant polymerized product. Examples of such monomers include aromatic (meth) acrylates, such as phenyl (meth)acrylate, 2-phenylethyl (meth)acrylate, 2-phenoxyethyl methacrylate, and benzyl (meth)acrylate.

The silicone hydrogels such as contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative. The examples should not be read as limiting the scope of the invention as defined in the claims.

In the examples, the following abbreviations are used.

HEMA: 2-hydroxyethyl methacrylate.

NVP: N-vinyl-2-pyrrolidone.

DMA: N,N-dimethylacrylamide.

EGDMA: Ethylene glycol dimethacrylate.

TRIS: Tris(trimethylsiloxy)silylpropyl methacrylate.

UV416: 2-(4-Benzoyl-3-hydroxyphenoxy)ethyl acrylate.

IMVT: 1,4-bis(4-(2-methacryloxyethyl)phenylamino)anthraquinone.

MIEDS6: A compound having the following structure and available from Gelest:

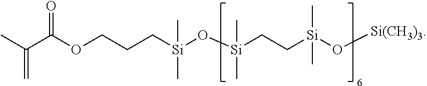

Ma2D37: A compound having the structure:

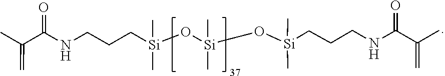

Various polymerization products were formed as discussed below and characterized by standard testing procedures such as:

Oxygen permeability (also referred to as Dk) is determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an 02 Permcometer Model 201T instrument (Createch, Albany, Calif. USA) having a probe comprising a central, circular gold cathode at its end and a silver anode insulated from the cathode. Measurements are taken only on pre-inspected pinhole-free, flat silicone hydrogel film samples of three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath comprising circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with a correlation coefficient value (R2) of 0.97 or higher should be entered into the calculation of Dk value. At least two Dk measurements per thickness, and meeting R² value, are obtained.

Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PBS and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom Vis Sci 7 (12s): 95 (1997), the disclosure of which is incorporated herein in its entirety.

Water %: Two sets of six hydrated lenses or films are blotted dry on a piece of filter paper to remove excess water, and samples are weighed (wet weight). Samples are then placed in a microwave oven for 10 minutes inside a jar containing desiccant. The samples are then allowed to sit for 30 minutes to equilibrate to room temperature and reweighed (dry weight). The percent water is calculated from the wet and dry weights.

Modulus (g/mm²) was measured per ASTM 1708 employing an Instron (Model 4502) instrument where the film sample was immersed in borate buffered saline; an appropriate size of the film sample was gauge length 22 mm and width 4.75 mm, where the sample further has ends forming a dog-bone shape to accommodate gripping of the sample with clamps of the Instron instrument, and a thickness of 100±50 microns.

UV Blocking: was measured by employing a Jasco V-760 UV-vis spectrophotometer using a % transmittance sweep from 800 nm to 200 nm. Visible light transmission (VLT), UVA and UVB blocking was calculated by averaging the % transmission across the ranges of 381 to 780 nm for VLT, 316 to 380 nm for UVA and 280 to 315 nm for UVB.

### Example 1

Preparation of a silicone monomer having the following structure:

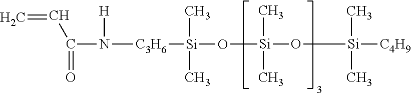

by the general reaction scheme.

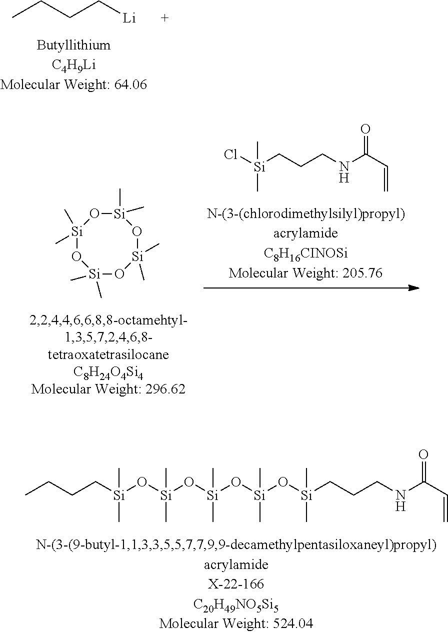

To an oven dried 2 L two-neck round bottom flask equipped with a magnetic stirring bar and condenser under N2 atmosphere were added 2,2,4,4,6,6,8,8-octamethyl-1,3,5,7,2,4,6,8-tetraoxatetrasilocane (29.6 g g, 0.1 mol) and anhydrous cyclohexane (150 mL) under stirring in N₂ atmosphere. Butyllithium (6.4 g, 0.1 mol) was added to the above reaction mixture followed by the addition of cyclohexane (25 mL). After stirring for one hour, tertrahydrofuran (THF) (70 mL, distilled over sodium/benzophenone) was added and the reaction mixture continued to stir for 16 hours. Next, N-(3-(chlorodimethylsilyl)propyl)acrylamide (20.5 g, 0.1 mol) was added and the mixture was stirred for another 24 hours. The reaction mixture was then filtered and Silica gel (3.5 g, dried at 160° C. for 3 h) was added and the reaction mixture was stirred for an additional 4 hours. The reaction mixture was filtered through a bed of Celite (20 g) and butylated hydroxytoluene (BHT) (5 mg) was added to the filtrate. The filtrate was then concentrated under vacuum (40° C./0.3 mm Hg). Heptane (200 mL) was added to the concentrate with stirring and washed with DI water (100 mL), aqueous NaHCO₃ (2×100 mL, prepared by dissolving 10 g NaHCO₃ in 200 mL DI water), brine (100 mL) and finally DI water (100 mL). Heptane (50 mL) was added and dried over MgSO₄ (15 g) for 20 hours. The MgSO₄ was filtered off and the solvent was removed on rotary evaporator. The crude product was stirred over activated basic Alumina (30 g for 24 h) and then filtered over a thin bed of celite. Stripping off any residue solvent at 25° C. at 0.2 mmHg for 30 minutes yielded the desired product as clear oil in 40 g quantity.

### Example 2 and Comparative Examples A and B

A monomeric mix was made by mixing the following components, listed in Table 1 at amounts per weight.

TABLE 1

| | | Comp. | Comp. |
|---|---|---|---|
| | Ex. 2 | Ex. A | Ex. B |
| Formulation | | | |
| Tris | 25.00 | 28.00 | 33.99 |
| Ma2D37 | 6.00 | 6.00 | 6.89 |
| M1EDS6 | 15.00 | 15.00 | 12.37 |
| Silicone Monomer | 8.64 | — | — |
| of Example 1 | | | |
| NVP | 31.74 | 34.00 | 30.09 |
| EGDMA | 0.10 | 0.10 | — |
| DMA | 7.00 | 7.00 | 4.63 |
| HEMA | — | 1.00 | 4.63 |
| Hexanol | 5.00 | 7.38 | 6.94 |
| UV-416 | 1.00 | 1.00 | — |
| IMVT | 0.02 | 0.02 | 0.02 |
| Irgacure 819 | 0.50 | 0.50 | 0.46 |
| Properties | | | |
| Water content, % | 50 | 55 | 46 |
| Modulus | 55 | 50 | 70 |
| Dk | 126 | 107 | 114 |
| UV Blocking | Yes | Yes | No |

The resultant monomeric mixture was cast into contact lenses by introducing the monomeric mixture to a polypropylene mold assembly. Then, the mold assembly and monomeric mixture were thermally cured for about 3 hours to form a contact lens. The resultant contact lenses were released from the mold assembly.

The silicone hydrogel of Example 2 had a significantly higher oxygen permeability (Dk) as compared to the silicone hydrogels of Comparative Examples A and B.

According to an aspect of the disclosure, a silicone hydrogel is a polymerization product of a monomeric mixture comprising:

(a) one or more monofunctional silicone monomers represented by a structure of Formula I:

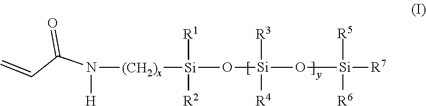

wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 15, and

(b) one or more silicone hydrogel-forming silicone comonomers.

In non-limiting illustrative embodiments, as may be combined with one or more of the preceding paragraphs, where in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 15.

In non-limiting illustrative embodiments, as may be combined with one or more of the preceding paragraphs, where in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 15.

In non-limiting illustrative embodiments, as may be combined with one or more of the preceding paragraphs, where in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

In non-limiting illustrative embodiments, as may be combined with one or more of the preceding paragraphs, where in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 15.

In non-limiting illustrative embodiments, as may be combined with one or more of the preceding paragraphs, the one or more silicone hydrogel-forming silicone comonomers comprise one or more non-bulky organosilicon-containing monomers.

In non-limiting illustrative embodiments, as may be combined with one or more of the preceding paragraphs, the one or more non-bulky organosilicon-containing monomers contain at least one [siloxanyl] or at least one [silyl-alkyl-siloxanyl] repeating unit in a monomer, macromer or prepolymer.

In non-limiting illustrative embodiments, as may be combined with one or more of the preceding paragraphs, the one or more non-bulky organosilicon-containing monomers comprise one or more non-bulky organosilicon-containing monomers represented by a structure of Formula II:

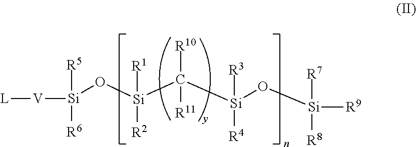

wherein L is an ethylenically unsaturated polymerizable group, V is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

In non-limiting illustrative embodiments, as may be combined with one or more of the preceding paragraphs, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In non-limiting illustrative embodiments, as may be combined with one or more of the preceding paragraphs, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

In non-limiting illustrative embodiments, as may be combined with one or more of the preceding paragraphs, the one or more non-bulky organosilicon-containing monomers comprise one or more non-bulky organosilicon-containing monomers represented by a structure of Formula III:

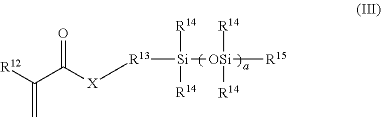

wherein R¹² is H or methyl; X is O or NR¹⁶; wherein R¹⁶ is selected from H, or C₁ to C₄ alkyl, which may be further substituted with one or more hydroxyl groups; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof; each R¹⁴ is independently a phenyl or a C₁ to C₄ alkyl group which may be substituted with fluorine, hydroxyl or ether; R¹⁵ is a C₁ to C₄ alkyl group; a is 2 to 50

In non-limiting illustrative embodiments, as may be combined with one or more of the preceding paragraphs, the one or more silicone hydrogel-forming silicone comonomers comprise one or more polysiloxane prepolymers represented by a structure of Formula IV:

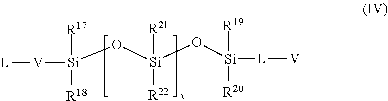

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

In non-limiting illustrative embodiments, as may be combined with one or more of the preceding paragraphs, V is an amine-containing reactive functional end group.

In non-limiting illustrative embodiments, as may be combined with one or more of the preceding paragraphs, the amine-containing reactive functional end group is a (meth)acrylamide-containing reactive functional end group.

In non-limiting illustrative embodiments, as may be combined with one or more of the preceding paragraphs, the one or more silicone hydrogel-forming silicone comonomers comprise one or more bulky silicone comonomers.

In non-limiting illustrative embodiments, as may be combined with one or more of the preceding paragraphs, the one or more bulky silicone comonomers comprise one or more bulky silicone-containing comonomers represented by a structure of Formula V:

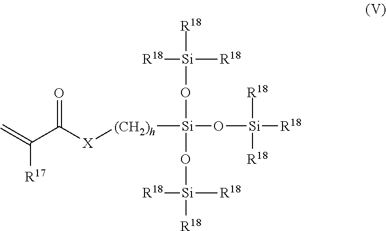

wherein X denotes —O— or —NR¹⁹—, wherein R¹⁹ is hydrogen or a C₁-C₄ alkyl group; each R¹⁷ independently denotes hydrogen or methyl; each R¹⁸ independently denotes a C₁-C₆ alkyl group, a phenyl group or a group represented by:

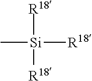

wherein each R¹⁸′ independently denotes a C₁-C₆ alkyl, or a phenyl radical; and h is 1 to 10, and one or more bulky silicone-containing comonomers represented by a structure of Formula VI:

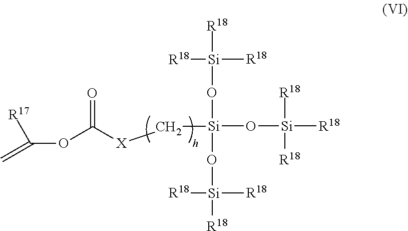

wherein X denotes —NR¹⁹—, wherein R¹⁹ denotes hydrogen or a C₁-C₄ alkyl group; R¹⁷ denotes hydrogen or methyl; each R¹⁸ independently denotes a C₁-C₆ alkyl group, a phenyl group or a group represented by:

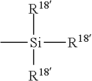

wherein each R¹⁸′ independently denotes a C₁-C₆ alkyl group, or a phenyl group; and h is 1 to 10.

In non-limiting illustrative embodiments, as may be combined with one or more of the preceding paragraphs, the monomeric mixture comprises:

(a) from about 5 wt. % to about 40 wt. %, based on the total weight of the monomeric mixture, of the one or more monofunctional silicone monomers and

(b) from about 10 wt. % to about 60 wt. %, based on the total weight of the monomeric mixture, of the one or more silicone hydrogel-forming silicone comonomers.

In non-limiting illustrative embodiments, as may be combined with one or more of the preceding paragraphs, the monomeric mixture comprises:

(a) from about 7 wt. % to about 15 wt. %, based on the total weight of the monomeric mixture, of the one or more monofunctional silicone monomers; and

(b) from about 15 wt. % to about 50 wt. %, based on the total weight of the monomeric mixture, of the one or more silicone hydrogel-forming silicone comonomers.

In non-limiting illustrative embodiments, as may be combined with one or more of the preceding paragraphs, the monomeric mixture further comprises one or more hydrophilic comonomers.

In non-limiting illustrative embodiments, as may be combined with one or more of the preceding paragraphs, the one or more hydrophilic comonomers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more hydrophilic comonomers are selected from the group consisting of an acrylamide, a vinyl lactam and a hydroxyl-containing-(meth)acrylate.

In non-limiting illustrative embodiments, as may be combined with one or more of the preceding paragraphs, the monomeric mixture comprises about 20 wt. % to 50 wt. %, based on the total weight of the monomeric mixture, of the one or more hydrophilic comonomers.

In non-limiting illustrative embodiments, as may be combined with one or more of the preceding paragraphs, the monomeric mixture further comprises one or more of one or more crosslinking agents, one or more reactive ultraviolet light absorbers and one or more reactive blue-light absorbers.

In non-limiting illustrative embodiments, as may be combined with one or more of the preceding paragraphs, The silicone hydrogel has an equilibrium water content of from about 50 wt. % to about 80 wt. %.

In non-limiting illustrative embodiments, as may be combined with one or more of the preceding paragraphs, the silicone hydrogel has an oxygen permeability of about 120 or greater.

According to another aspect of the disclosure, a method for making a silicone hydrogel, comprises:

(a) curing a monomeric mixture in a mold, the monomeric mixture comprising:

(i) one or more monofunctional silicone monomers represented by a structure of Formula I:

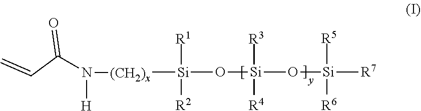

wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 15, and

(ii) one or more silicone hydrogel-forming silicone comonomers, and

(b) releasing the silicone hydrogel from the mold.

In non-limiting illustrative embodiments, as may be combined with one or more of the preceding paragraphs, where in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 15.

In non-limiting illustrative embodiments, as may be combined with one or more of the preceding paragraphs, where in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 15.

In non-limiting illustrative embodiments, as may be combined with one or more of the preceding paragraphs, where in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

In non-limiting illustrative embodiments, as may be combined with one or more of the preceding paragraphs, where in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 15.

In non-limiting illustrative embodiments, as may be combined with one or more of the preceding paragraphs, the one or more silicone hydrogel-forming silicone comonomers comprise one or more non-bulky organosilicon-containing monomers.

In non-limiting illustrative embodiments, as may be combined with one or more of the preceding paragraphs, the one or more non-bulky organosilicon-containing monomers contain at least one [siloxanyl] or at least one [silyl-alkyl-siloxanyl] repeating unit in a monomer, macromer or prepolymer.

In non-limiting illustrative embodiments, as may be combined with one or more of the preceding paragraphs, the one or more non-bulky organosilicon-containing monomers comprise one or more non-bulky organosilicon-containing monomers represented by a structure of Formula II:

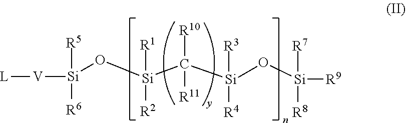

wherein L is an ethylenically unsaturated polymerizable group, V is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

In non-limiting illustrative embodiments, as may be combined with one or more of the preceding paragraphs, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In non-limiting illustrative embodiments, as may be combined with one or more of the preceding paragraphs, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

In non-limiting illustrative embodiments, as may be combined with one or more of the preceding paragraphs, the one or more non-bulky organosilicon-containing monomers comprise one or more non-bulky organosilicon-containing monomers represented by a structure of Formula III:

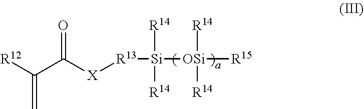

wherein R¹² is H or methyl; X is O or NR¹⁶; wherein R¹⁶ is selected from H, or C₁ to C₄ alkyl, which may be further substituted with one or more hydroxyl groups; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof; each R¹⁴ is independently a phenyl or a C₁ to C₄ alkyl group which may be substituted with fluorine, hydroxyl or ether; R¹⁵ is a C₁ to C₄ alkyl group; a is 2 to 50.

In non-limiting illustrative embodiments, as may be combined with one or more of the preceding paragraphs, the one or more silicone hydrogel-forming silicone comonomers comprise one or more polysiloxane prepolymers represented by a structure of Formula IV:

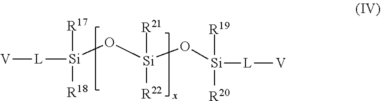

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

In non-limiting illustrative embodiments, as may be combined with one or more of the preceding paragraphs, V is an amine-containing reactive functional end group.

In non-limiting illustrative embodiments, as may be combined with one or more of the preceding paragraphs, the amine-containing reactive functional end group is a (meth)acrylamide-containing reactive functional end group.

In non-limiting illustrative embodiments, as may be combined with one or more of the preceding paragraphs, the one or more silicone hydrogel-forming silicone comonomers comprise one or more bulky silicone comonomers.

In non-limiting illustrative embodiments, as may be combined with one or more of the preceding paragraphs, the one or more bulky silicone comonomers comprise one or more bulky silicone-containing comonomers represented by a structure of Formula V:

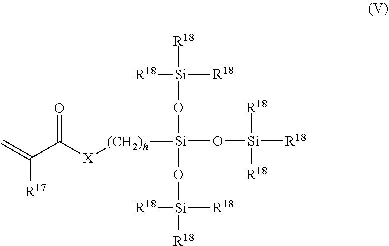

wherein X denotes —O— or —NR¹⁹—, wherein R¹⁹ is hydrogen or a C₁-C₄ alkyl group; each R¹⁷ independently denotes hydrogen or methyl; each R¹⁸ independently denotes a C₁-C₆ alkyl group, a phenyl group or a group represented by:

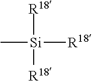

wherein each R¹⁸ independently denotes a C₁-C₆ alkyl, or a phenyl radical; and h is 1 to 10, and In non-limiting illustrative embodiments, as may be combined with one or more of the preceding paragraphs, Formula VI:

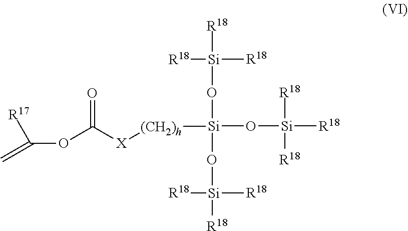

wherein X denotes —NR¹⁹—, wherein R¹⁹ denotes hydrogen or a C₁-C₄ alkyl group; R¹⁷ denotes hydrogen or methyl; each R¹⁸ independently denotes a C₁-C₆ alkyl group, a phenyl group or a group represented by:

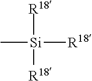

wherein each R^{18′} independently denotes a C₁-C₆ alkyl group, or a phenyl group; and h is 1 to 10.

In non-limiting illustrative embodiments, as may be combined with one or more of the preceding paragraphs, the monomeric mixture comprises:

(a) from about 5 wt. % to about 40 wt. %, based on the total weight of the monomeric mixture, of the one or more monofunctional silicone monomers; and

(b) from about 10 wt. % to about 60 wt. %, based on the total weight of the monomeric mixture, of the one or more silicone hydrogel-forming silicone comonomers.

In non-limiting illustrative embodiments, as may be combined with one or more of the preceding paragraphs, the monomeric mixture comprises:

(a) from about 7 wt. % to about 15 wt. %, based on the total weight of the monomeric mixture, of the one or more monofunctional silicone monomers; and

(b) from about 15 wt. % to about 50 wt. %, based on the total weight of the monomeric mixture, of the one or more silicone hydrogel-forming silicone comonomers.

In non-limiting illustrative embodiments, as may be combined with one or more of the preceding paragraphs, the monomeric mixture further comprises one or more hydrophilic comonomers.

In non-limiting illustrative embodiments, as may be combined with one or more of the preceding paragraphs, the one or more hydrophilic comonomers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more hydrophilic comonomers are selected from the group consisting of an acrylamide, a vinyl lactam and a hydroxyl-containing-(meth)acrylate.

In non-limiting illustrative embodiments, as may be combined with one or more of the preceding paragraphs, the monomeric mixture further comprises about 20 wt. % to 50 wt. %, based on the total weight of the monomeric mixture, of the one or more hydrophilic comonomers.

In non-limiting illustrative embodiments, as may be combined with one or more of the preceding paragraphs, the monomeric mixture further comprises one or more of one or more crosslinking agents, one or more reactive ultraviolet light absorbers and one or more reactive blue-light absorbers.

In non-limiting illustrative embodiments, as may be combined with one or more of the preceding paragraphs, the silicone hydrogel has an equilibrium water content of from about 50 wt. % to about 80 wt. %.

In non-limiting illustrative embodiments, as may be combined with one or more of the preceding paragraphs, the silicone hydrogel has an oxygen permeability of about 120 or greater.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A silicone hydrogel which is a polymerization product of a monomeric mixture comprising:
(a) one or more monofunctional silicone monomers represented by a structure of Formula I: 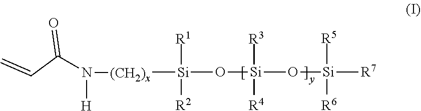
wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group;
R⁵, R⁶ and R⁷ are independently a straight or branched C₁ to C₁₂ alkyl group, x is from 1 to 6, and y is from 3 to 15; and
(b) one or more silicone hydrogel-forming silicone comonomers.

2. The silicone hydrogel according to claim 1, wherein in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 15.

3. The silicone hydrogel according to claim 1, wherein in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 15.

4. The silicone hydrogel according to claim 1, wherein in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

5. The silicone hydrogel according to claim 1, wherein in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 15.

6. The silicone hydrogel according to claim 1, wherein the one or more silicone hydrogel-forming silicone comonomers comprise one or more non-bulky organosilicon-containing monomers.

7. The silicone hydrogel according to claim 6, wherein the one or more non-bulky organosilicon-containing monomers contain at least one [siloxanyl] or at least one [silyl-alkyl-siloxanyl] repeating unit in a monomer, macromer or prepolymer.

8. The silicone hydrogel according to claim 6, wherein the one or more non-bulky organosilicon-containing monomers comprise one or more non-bulky organosilicon-containing monomers represented by a structure of Formula I: 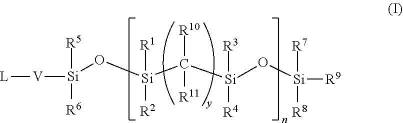
wherein L is an ethylenically unsaturated polymerizable group, V is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

9. The silicone hydrogel according to claim 1, wherein the one or more silicone hydrogel-forming silicone comonomers comprise one or more polysiloxane prepolymers represented by a structure of Formula II: 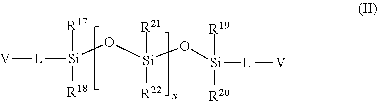
wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

10. The silicone hydrogel according to claim 9, wherein V is an amine-containing reactive functional end group.

11. The silicone hydrogel according to claim 10, wherein the amine-containing reactive functional end group is a (meth)acrylamide-containing reactive functional end group.

12. The silicone hydrogel according to claim 1, wherein the monomeric mixture comprises:
(a) from about 5 wt. % to about 40 wt. %, based on the total weight of the monomeric mixture, of the one or more monofunctional silicone monomers; and
(b) from about 10 wt. % to about 60 wt. %, based on the total weight of the monomeric mixture, of the one or more silicone hydrogel-forming silicone comonomers.

13. The silicone hydrogel according to claim 1, wherein the monomeric mixture comprises:
(a) from about 7 wt. % to about 15 wt. %, based on the total weight of the monomeric mixture, of the one or more monofunctional silicone monomers; and
(b) from about 15 wt. % to about 50 wt. %, based on the total weight of the monomeric mixture, of the one or more silicone hydrogel-forming silicone comonomers.

14. The silicone hydrogel according to claim 1, wherein the monomeric mixture further comprises one or more hydrophilic comonomers.

15. The silicone hydrogel according to claim 14, wherein the one or more hydrophilic comonomers are selected from the group consisting of an acrylamide, a vinyl lactam and a hydroxyl-containing-(meth)acrylate.

16. The silicone hydrogel according to claim 14, wherein the monomeric mixture comprises:
about 20 wt. % to 50 wt. %, based on the total weight of the monomeric mixture, of the one or more hydrophilic comonomers.

17. The silicone hydrogel according to claim 1, wherein the monomeric mixture further comprises one or more of one or more crosslinking agents, one or more reactive ultraviolet light absorbers and one or more reactive blue-light absorbers.

18. The silicone hydrogel according to claim 1, having an equilibrium water content of from about 50 wt. % to about 80 wt. %.

19. The silicone hydrogel according to claim 1, having an oxygen permeability of about 120 or greater.

20. A method for making a silicone hydrogel, comprising:
(a) curing a monomeric mixture in a mold, the monomeric mixture comprising:
(i) one or more monofunctional silicone monomers represented by a structure of Formula I: 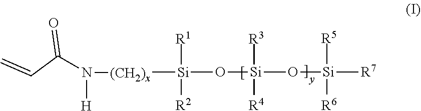
wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 15; and
(ii) one or more silicone hydrogel-forming silicone comonomers; and
(b) releasing the silicone hydrogel from the mold.
